(19) United States
(12) Patent Application Publication
(10) Pub. No.: US 2020/0298696 A1
(43) Pub. Date: Sep. 24, 2020

(54) BLOW MOLDED SUPPORT FOR INLET CHECK VALVE

(71) Applicant: Plastic Omnium Advanced Innovation and Research, Bruxelles (BE)

(72) Inventors: Camille DEVILLERS, Elincourt Sainte Marguerite (FR); Aurelien GATET, Gouvieux (FR); Yvonnig GUEZENNEC, Venette (FR)

(73) Assignee: Plastic Omnium Advanced Innovation and Research, Bruxelles (BE)

(21) Appl. No.: 16/089,563

(22) PCT Filed: Mar. 28, 2017
(86) PCT No.: PCT/EP2017/057303

§ 371 Date: Sep. 28, 2018

(30) Foreign Application Priority Data
Mar. 29, 2016 (EP) 16305363.0

(51) Int. Cl. B60K 15/04; B60K 15/03; F16K 15/03

(52) U.S. Cl. CPC B60K 15/04; B29C 49/04; F16K 15/03; B60K 15/03177

(57) ABSTRACT

The invention relates to a filler pipe (1) weldable to a liquid tank (3) of a vehicle, wherein the filler pipe comprises a main body (4), a secondary body (5) configured to support an inlet check valve (2) and a weldable flange (6) suitable for welding around an opening in the liquid tank (3), the weldable flange (6) extending between the main body (4) and the secondary body (5).

The present invention relates to a filler pipe welded to a liquid tank of a vehicle. More precisely, the present invention is related to a filler pipe which is able to support an inlet check valve.

The terms “liquid tank” are intended to denote a sealed tank able to store liquid under diverse and varying environmental and usage conditions. An example of liquid tank is a fuel tank fitted to motor vehicles.

The terms “filler pipe” are intended to denote a sealed pipe having two openings and through which fluid flows in order to fill a tank, in a downstream direction. The upstream direction in the filler pipe is the direction opposite to the downstream direction.

The terms “inlet check valve” or “check valve”, also called “clack valve”, “non-return valve” or “one-way valve”, are intended to denote a valve that normally allows liquid to flow through it in only one direction. The inlet check valve can be made of plastic or metal or a combination of plastic and metal.

Vehicles usually have many kinds of liquid tank on board, such as fuel tank, tank for urea storage, etc. These tanks are generally equipped with a filler pipe welded around an opening in a wall of the tank and through which the tank is filled.

This opening of the tank, around which one end of the filler pipe is welded, is generally equipped with an inlet check valve to prevent the liquid flowing back to the filler pipe, said inlet check valve is generally welded between the tank and the filler pipe or fixed inside the filler pipe, at its downstream end, at the level of the welding interface between filler pipe and liquid tank.

Filler pipes, especially parts of filler pipes, which interfere with inlet check valves, have experienced many different shapes to allow fixation of said inlet check valves. However, almost none of filler pipe shapes provides an accurate alignment between the inlet check valve and the filler pipe, especially after the welding step between the filler pipe and the liquid tank and, which can cause some mechanical effects that move the inlet check valve from its correct positioning.

In the patent application no EP15306253, in the name of the applicant, filler pipe shape is designed to prevent any movement, neither upstream, nor downstream of the inlet check valve after its insertion inside the filler pipe. Indeed, the internal surface of the filler pipe is designed to present some recesses which allow hook means of the inlet check valve to be hardly fixed in during the insertion of the inlet check valve inside the filler pipe, which makes it possible to manipulate the filler pipe and to weld it to the tank. In this solution, the inlet check valve is a complex element. It comprises, additionally to the gate and the tube which are required to allow basic function of such a valve, welding elements like radial flange 27, conical skirt 25 and edge 29. All of this additional elements increase pricing and manufacturing time of inlet check valves according to this prior art. Complexity of said filler pipe shapes is also increased because of required adaptations in regard to said additional elements, in order to prevent any movement of the inlet check valve in the downstream direction, during the welding step between the filler pipe and the liquid tank. However, it is still difficult to control good positioning of welding elements of inlet check valve at the welding interface between the filler pipe and the liquid tank and, thus, it is complicated to control good welding or overmoulding of said welding elements, which can cause a misalignment between the inlet check valve and the filler pipe but also between the inlet check valve and the tank. Such misalignments may lead to leak problems and non-robust welding interfaces.

It is therefore an object of the invention to provide filler pipes which allow an accurate and definitive positioning of less complex inlet check valves and which do not demonstrate the above drawbacks.

The invention relates to a filler pipe weldable to a liquid tank of a vehicle, comprising a main body, a secondary body configured to support an inlet check valve and a weldable flange suitable for welding around an opening in the liquid tank, the weldable flange extending between the main body and the secondary body.

In a particular embodiment, a filler pipe according to the invention can comprise at least three independent parts, a main body, a secondary body and a weldable flange which can be put together, by all known means, to form the filler pipe of the invention. One of said three parts, the secondary body, is designed to support an inlet check valve inside the liquid tank, around the opening in said liquid tank. Such a part of the filler pipe, extending after the weldable flange, does not interfere with the welding interface, during the welding step between the filler pipe and the liquid tank, which allows an easier welding and also a secured positioning of the inlet check valve. Indeed, such an inlet check valve, which is positioned before the welding step, is not impacted by this welding step and, thus, does not present the risk to be misaligned which prevents leak problems.

In another embodiment, the filler pipe according to the invention can comprise at least three portions, a main body, a secondary body and a weldable flange which are made in one piece. According to the invention, parts “made in one piece” shall be construed as parts providing, together, one single component which is made in one piece. The filler pipe can be obtained by all known processes where a plastic preform is moulded. Examples of such processes are, but not limited to, blow-moulding process, injection-moulding process or thermoforming process.

Such a blow-moulding process comprises the following steps:
laying the parison by a robot in a bottom cavity of a mold having clip parts with a suitable clipping shape to allow the secondary body to support an inlet check valve;
closing the mold and preblowing the parison;
moving compression parts of the mold during preblowing;
moving forward the blowing needle and blowing the compressed parison;
cutting the end of the filler pipe before end of blowing;
moving back the clip parts and the compression parts;
opening the mold and ejection of the molded filler pipe.

Filler pipes according to the invention are preferably made of plastic, that is to say, of a material comprising at least one synthetic resin polymer. All types of plastic may be suitable. Particularly suitable plastics come from the thermoplastic category. The term “thermoplastic” denotes any thermoplastic polymer including thermoplastic elastomers, as well as blends thereof. The term “polymer” denotes both homopolymers and copolymers (especially binary or ternary copolymers). Examples of such copolymers are, but not limited to, random copolymers, linear block copolymers, other block copolymers and graft copolymers. One polymer which is often used is polyethylene. Excellent results have been obtained with high density polyethylene (HDPE).

In a particular embodiment, the secondary body of the filler pipe comprises at least one support means for an inlet check valve. Such a support means can be present on the internal surface of the secondary body, on the external surface of the secondary body or on both.

According to an advantageous aspect of this embodiment, the secondary body of the filler pipe comprises screw thread for the screwing of an inlet check valve.

According to another advantageous aspect of this embodiment, the secondary body of the filler pipe comprises at least one recess, inside which fixation means of an inlet check valve can be fixed. It is also a possible option that at least one recess is comprised on the internal surface of the secondary body and at least one other recess is comprised on the external surface of the secondary body. By doing so, fixation strength of the inlet check valve can be increased. In another embodiment, the at least one recess can be comprised on the internal surface of the main body.

According to another advantageous aspect of this embodiment, the secondary body comprises at least a portion of its entire surface which is made of a material which allows the welding of an inlet check valve. In other words, such a portion is made of material compatible with the material of the welding portion of the inlet check valve.

In another particular embodiment, the secondary body is designed to allow the placement or the fixation of at least one seal element. Advantageously, the secondary body comprises an abutment or a groove for the placement of a seal element. The seal element can be placed or fixed on the secondary body, before the step of inlet check valve mounting. Such a seal element can also be a part of the inlet check valve and, thus, be placed or fixed during the step of inlet check valve mounting.

Advantageously, the weldable flange of the filler pipe according to the invention is made of a material which is compatible with the material of the welding area of the tank, which is the area corresponding at least to the exact surface of the tank wall where the weldable flange is welded. Preferably, the filler pipe has a layer made of a material which is chemically compatible with a layer of the tank.

According to another embodiment of the invention, the filler pipe is made of a multilayer plastic material having a fuel impermeable layer. The impermeable layer is preferably a layer of a resin impermeable to the fuel, such as EVOH for example (a copolymer of ethylene and partially hydrolyzed vinyl acetate).

According to an embodiment of the invention, the filler pipe has a treated external surface (by fluoration or sulphonation) which renders the filler pipe impermeable to fuel.

The present invention also relates to a set of an inlet check valve mounted on the secondary body of a filler pipe previously described.

According to an embodiment of the invention, the inlet check valve is welded to the secondary body of a filler pipe previously described. Therefore, at least a welding portion of said inlet check valve, which is the surface welded to the secondary body, has to be made of a compatible material with material of the corresponding welded portion of the secondary body. Preferably, the entire surface of the inlet check valve is made of a material which is chemically compatible with the corresponding welded portion of the secondary body.

According to a particular embodiment of the invention, the inlet check valve can be placed inside the secondary body when the filler pipe is still hot, for example, just after the exit of the moulds. During the cooling of the filler pipe, hot material is shrinking and thus, wedged irreversibly the inlet check valve inside filler pipe.

Inlet check valves, according to said set of the invention, can all be inlet check valves, known from the man skilled in the art, which comprise at least a tube inside which liquid flows in a downstream direction, and a gate which prevents the liquid flowing back to the filler pipe.

The present invention also relates to an assembly composed of a liquid tank of a vehicle and of the set previously described, the filler pipe being welded to the tank.

The liquid tank according to the assembly of the invention are preferably also made of plastic, as already described for plastic used for manufacturing filler pipes.

According to an embodiment of the invention, the liquid tank is a fuel tank made of a multilayer plastic material having a fuel impermeable layer. Preferably, the external layer of the multilayer plastic material liquid tank is chemically compatible with the external layer of a multilayer plastic material filler pipe.

According to an embodiment of the invention, the liquid tank is a fuel tank having a treated external surface (by fluoration or sulphonation) which renders the tank impermeable to fuel.

The invention will be better understood through the following figures which illustrate certain practical aspects of the invention. The figures are only shown as examples and do not limit the scope of the present invention.

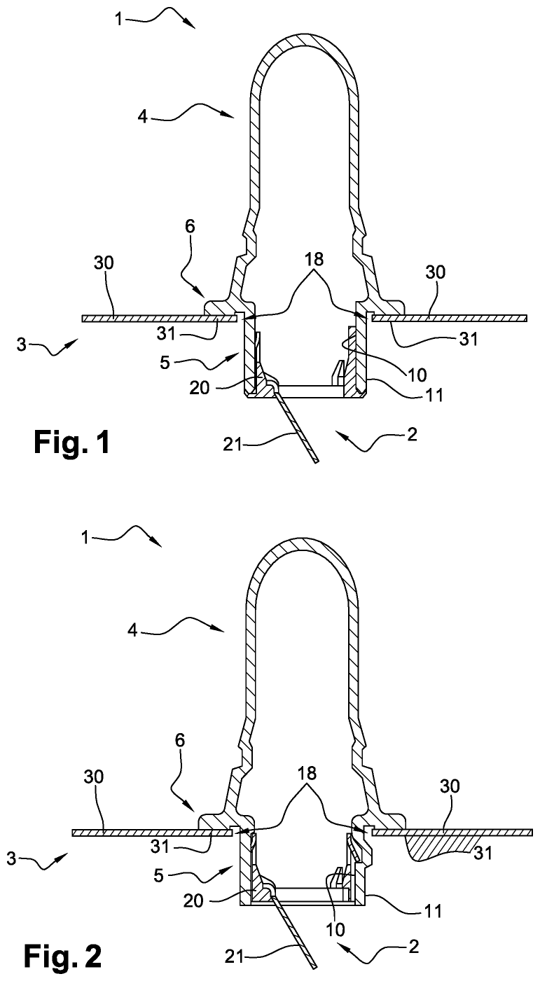

FIG. 1 is a longitudinal sectional view of an assembly of a liquid tank and a set of a filler pipe and an inlet check valve according to a first embodiment of the invention.

FIG. 2 is a longitudinal sectional view of an assembly of a liquid tank and a set of a filler pipe and an inlet check valve according to a second embodiment of the invention.

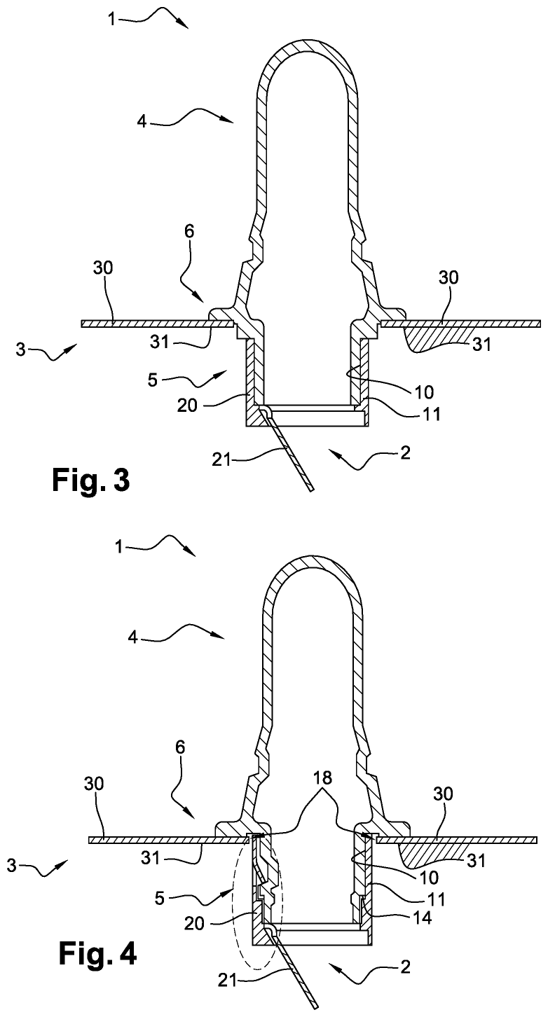

FIG. 3 is a longitudinal sectional view of an assembly of a liquid tank and a set of a filler pipe and an inlet check valve according to a third embodiment of the invention.

FIG. 4 is a longitudinal sectional view of an assembly of a liquid tank and a set of a filler pipe and an inlet check valve according to a fourth embodiment of the invention.

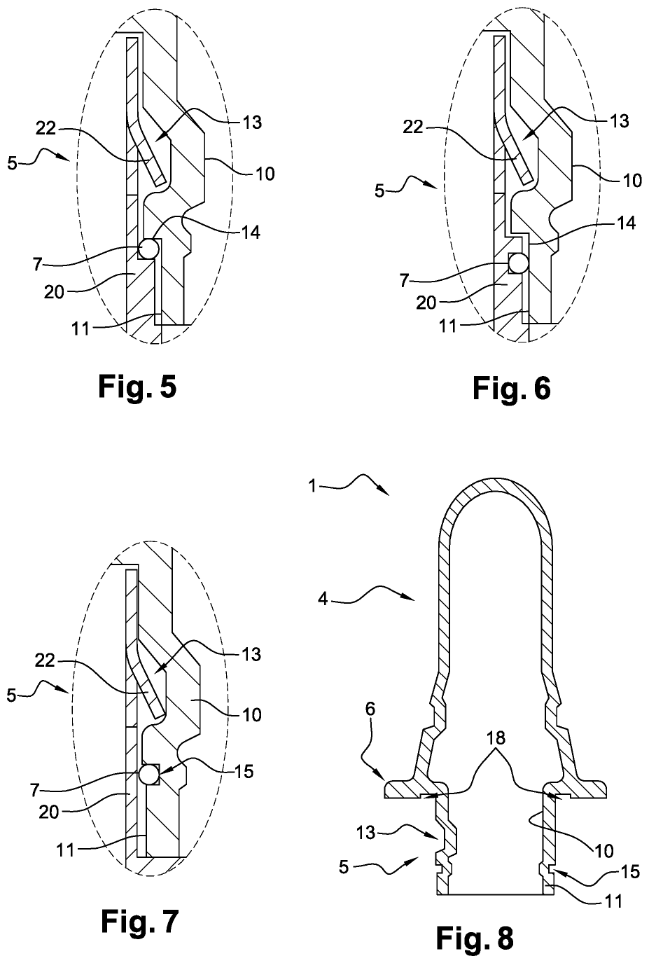

FIGS. 5 to 7 shows enlargements of delimited zone of FIG. 4 which represent different alternatives of the set of a filler pipe and an inlet check valve, comprising a sealing element.

FIG. 8 is a longitudinal sectional view of a filler pipe relating to the enlargement shown FIG. 7.

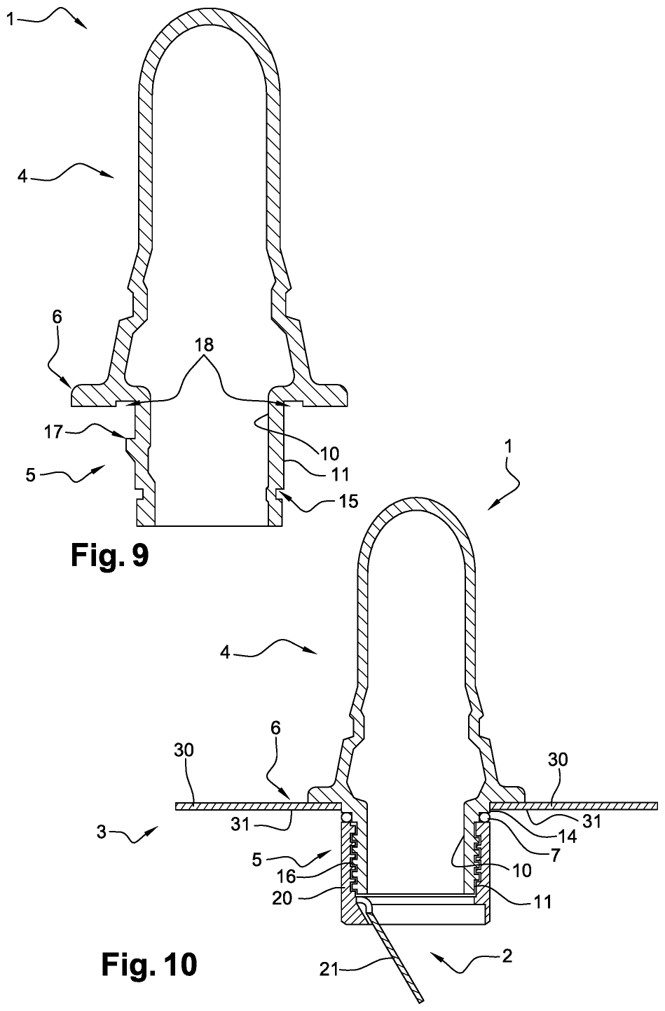

FIG. 9 is a longitudinal sectional view of a filler pipe according to a fifth embodiment of the invention.

FIG. 10 is a longitudinal sectional view of an assembly of a liquid tank and a set of a filler pipe and an inlet check valve according to a sixth embodiment of the invention.

Now, we refer to FIG. 1.

FIG. 1 is a longitudinal sectional view showing a filler pipe 1 supporting an inlet check valve 2 and welded to a liquid tank 3 of a vehicle. Such a filler pipe 1 comprises a main body 4, a secondary body 5 and a weldable flange 6 extending between the main body 4 and the secondary body 5, which are made in one piece and obtained by blow moulding of a parison made of a plastic material which can be fuel impermeable, to an extent defined by legal requirements, either thanks to its thickness as a monolayer wall, or thanks to the presence of a fuel impermeable layer included in its multilayer wall. In this first embodiment of the invention, the inlet check valve 2 is welded to the internal surface 10 of the secondary body 5, which is made of a material compatible with the external surface of the inlet check valve 2 for securing the alignment of said inlet check valve 2. Consequently, the diameter of inlet check valve 2 is smaller than the diameter of secondary body 5 of the filler pipe 1, which reduces the flow rate and increases the filling time of the liquid tank 3, for a secondary body 5 with a given diameter.

The set of a filler pipe 1 and an inlet check valve 2 is welded to the wall 30 of the liquid tank 3 thanks to the weldable flange 6 of the filler pipe 1. Secondary body 5, which is extending after the weldable flange 6 and on which is mounted inlet check valve 2, does not interfere with the welding interface, during the welding step between the filler pipe 1 and the liquid tank 3, which prevents any misalignment between the inlet check valve 2 and the filler pipe 1, due to this welding step. The weldable flange 6 is made of a material which is compatible with the material of the welding area 31 of the tank 3, which is the area corresponding at least to the exact surface of the tank wall where the weldable flange 6 is welded. The weldable flange 6 is also provided with recesses 18 inside which material of the welding area 31 of the tank 3 can move when it is pressed during the welding step. Such a material displacement allows to improve the robustness of welding interfaces between the filler pipe 1 and the tank 3. In another embodiment, such recesses 18 can have different shape and dimension than shape and dimension of recesses 18 of FIG. 1, for example, recesses 18 can be designed with a dove-tail shape.

The inlet check valve 2 is a common inlet check valve, known from the skilled man of the art, which comprises at least a tube 20 inside which liquid flows in a downstream direction and a gate 21 which prevents the liquid flowing back to the filler pipe.

The longitudinal sectional view of the FIG. 2 shows of an assembly of a liquid tank 3 and a set of a filler pipe 1 and an inlet check valve 2 according to a second embodiment of the invention, where unlike to FIG. 1, the internal surface 10 of the secondary body 5 is not welded to the inlet check valve 2. Indeed, in this embodiment of the invention, the secondary body comprises one recess 12 inside which fixation means 22 of inlet check valve 2 can be fixed. Hence, the external surface of inlet check valve 2 and internal surface 10 of the secondary body 5 do not need to be made of a material compatible, which presents the advantage to broad the choice of suitable inlet check valves for this embodiment of the invention.

FIG. 3 shows a third embodiment of the invention which is quite similar to the first embodiment shown at FIG. 1, except that the welding between the secondary body 5 and the external surface of the inlet check valve 2 is occurring on the external surface 11 of the secondary body 5. Hence, the flow rate does not depend on the diameter of the inlet check valve 2 but of the diameter of the secondary body 5, which solves the above mentioned issues.

FIG. 4 shows a fourth embodiment of the invention, similar to the second embodiment shown at FIG. 2, where external surface 11 of the secondary body 5 comprises one recess 13 inside which fixation means 22 of inlet check valve 2 can be fixed. External surface 11 of the secondary body 5 comprises also one abutment 14 which also serves to maintain inlet check valve 2 in a good position. Such an abutment 14 is also used for sealing purposes as it is exemplified at FIGS. 5 and 6.

FIG. 5 shows an enlargement of delimited zone of FIG. 4, where one sealing element 7 is placed against the abutment 14 before mounting step of the inlet check valve 2 on the secondary body 5.

FIG. 6 shows an alternative of the enlargement of delimited zone of FIG. 4 where a sealing element 7 is a part of an inlet check valve 2. This alternative offers the advantage that the placement of the sealing element 7 and the mounting step of the inlet check valve 2 are carried out in a single operation.

FIG. 7 shows another alternative of the enlargement of delimited zone of FIG. 4, where external surface 11 of the secondary body 5 comprises one groove 15 inside which a sealing element 7 can be placed, in a secured way, before mounting step of the inlet check valve 2 on the secondary body 5. A filler pipe 1 according to this alternative is shown at FIG. 8, devoid of sealing element 7 and inlet check valve 2. All parts of this filler pipe 1 can be made in one piece and the moulding apparatus used for manufacturing such filler pipe is adapted to integrate the formation of said recess 13 and/or said groove 15 in secondary body 5.

FIG. 9 shows a filler pipe 1 according a fifth embodiment of the invention, devoid of sealing element 7 and inlet check valve 2, where external surface 11 of the secondary body 5 is provided with one clip 17 which is designed to be fixed inside one complementary recess (not shown) provided on the inlet check valve 2, in order to ensure coupling between said inlet check valve 2 and said filler pipe 1. In another embodiment, not shown, the secondary body 5 can be provided with more than one clip 17

FIG. 10 shows a sixth embodiment of the invention, where external surface 11 of the secondary body 5 is provided with screw thread 16 for the screwing of an inlet check valve 2. Secondary body 5 is also provided with an abutment 14 against which a sealing element 7 is placed or fixed before the screwing the inlet check valve 2. By doing so, the sealing element 7 is axially compressed, wedged between the abutment 14 and the inlet check valve 2, which improves the tightness of the welded assembly. In an alternative of this embodiment, such a sealing element 7 can also be radially compressed, like sealing elements 7 implemented in embodiments of FIGS. 5 to 7.

The invention is not limited to the above embodiments and other embodiments exist and will appear clearly to one skilled in the art.

1. A filler pipe weldable to a liquid tank of a vehicle, comprising:
a main body;
a secondary body configured to support an inlet check valve; and
a weldable flange suitable for welding around an opening in the liquid tank, the weldable flange extending between the main body and the secondary body, wherein the main body, the secondary body and the weldable flange are made in one piece, wherein the filler pipe is obtained by blow-moulding a plastic preform.

2. The filler pipe according to claim 1, wherein the secondary body comprises a screw thread for the screwing of an inlet check valve.

3. The filler pipe according to claim 1, wherein the secondary body comprises at least one recess inside which fixation means of an inlet check valve can be fixed.

4. The filler pipe according to claim 1, wherein the secondary body comprises an abutment or a groove for the placement of a seal element.

5. The filler pipe according to claim 1, wherein the filler pipe comprises a multilayer structure comprising a barrier layer.

6. A set of an inlet check valve and of a filler pipe according to claim 1, wherein the inlet check valve is mounted on the secondary body.

7. The set according to claim 6, wherein the inlet check valve is welded to the secondary body.

8. An assembly composed of a liquid tank of a vehicle and of a set according to claim 6, wherein the filler pipe is welded to the liquid tank.
